(19) United States
(12) Patent Application Publication
(10) Pub. No.: US 2016/0247232 A1
(43) Pub. Date: Aug. 25, 2016

(54) EFFICIENT METHODS FOR PREDICTIVE ACTION STRATEGY OPTIMIZATION FOR RISK DRIVEN MULTI-CHANNEL COMMUNICATION

(71) Applicant: Xerox Corporation, Norwalk, CT (US)

(72) Inventors: Arvind Agarwal, Webster, NY (US); Shanmuga-Nathan Gnanasambandam, Victor, NY (US)

(21) Appl. No.: 14/627,040

(22) Filed: Feb. 20, 2015

(51) Int. Cl. G06Q 40/06

(52) U.S. Cl. CPC G06Q 40/06

(57) ABSTRACT

Presented are a method, system, and apparatus for using a specialized computing device managing a contact center to analyze and reduce financial risk on a portfolio of accounts (such as loans, insurance claims, etc.) via determining whether and, if so, when to utilize a communication channel (such as telephone, e-mail, text message, etc.) to contact a customer regarding a monitored account. Variables are received including action history and transactions associated with the monitored account. One or more risk models associated with the monitored account are derived. Risk level is determined for the customer. The derived risk models and the determined risk level are used to generate a risk-driven campaign optimization strategy. A solution maximizing advantage considering the risk-driven campaign optimization strategy is then generated, the solution including a determination of whether to contact the customer and, if so, which communication channel to utilize at which time t.

### TECHNICAL FIELD

The present invention is generally related to the field of risk assessment and strategic decision making for large account portfolios. More specifically, the invention is directed towards a system, method, and apparatus utilizing a specialized computing device managing a contact center to analyze and reduce future financial risk associated with a portfolio of monitored accounts via a determination by the specialized computing device of whether or not to contact a customer of multiple customers regarding an unperformed account action, and, if so, the specialized computing device makes a determination of which communication channel to utilize to contact the customer of one or more communication channels available.

### BACKGROUND

The personal lending industry, including the lending of student loans, auto loans, commercial loans, and mortgages, as well as other types of personal loans is valued at trillions of dollars in the United States in the twenty-first century. The total value of mortgages outstanding alone in the United States is approximately $10 trillion dollars. The total value of all student loans outstanding in the United States in 2013 is currently between $902 billion and $1 trillion. The sheer volume of this debt indicates that any time a large number of accounts may be in default. One statistic from Sep. 30, 2013 indicates 10% of borrowers default in two years of beginning repayment on student loans, and 14.7% default within three years of beginning repayment, both statistics an increase over analyzed statistics from previous years. “Default Rates Continue to Rise for Federal Student Loans,” U.S. DEPARTMENT OF EDUCATION, available at http://www.ed.gov/news/press-releases/default-rates-continue-rise-federal-student-loans (last visited Sep. 4, 2014). It could thus be roughly estimated that in the example of a lender/guarantor/servicer/other organization managing a portfolio of student loans (for example), more than 14% of customers might be expected to be in default at any time.

Lenders/guarantors/servicers or any other organization involved in reducing financial risk within any type of account portfolio (whether mortgages, auto loans, commercial loans, personal lines of credit, credit cards, or any other) always experience some level of financial risk, and desire to reduce it. Accordingly, a need exists for a system, method, and apparatus for managing risk associated with a portfolio of monitored accounts.

### SUMMARY

The present invention is directed to a system, method, and apparatus utilizing a specialized computing device managing a contact center to analyze and reduce future financial risk associated with a portfolio of monitored accounts via a determination by the specialized computing device of whether or not to contact a customer of multiple customers regarding an unperformed account action. The portfolio of monitored accounts may comprise loans, insurance claims, pending bills/liabilities, and medical/health actions. If the specialized computing device makes a determination of which communication channel to utilize to contact the customer of one or more communication channels available, the specialized computing device may make a further determination of which communication channel to utilize to make the contact. The one or more communication channels may comprise telephone calls, e-mails, text messages, web-chats, and social media messages.

In an embodiment of the invention, the invention comprises a system, method, and apparatus utilizing a specialized computing device managing a contact center to analyze and reduce future financial risk on a portfolio of monitored accounts via a determination of whether or not and, if so, when to utilize a communications channel of one or more communication channels available to contact a customer regarding a monitored account in the portfolio of monitored accounts, seeking to maximize advantage from contacting the customer to perform account-related pending actions while minimizing costs associated with contacting the customer.

Beginning execution, the specialized computing device receives a plurality of variables indicating action history and transactions associated with the monitored account held by the customer. The specialized computing device then stores into associated memory the plurality of variables indicating action history and transactions associated with the monitored account. The specialized computing device receives a variable defining a maximum look-ahead timeframe and a variable defining a periodic basis and stores the variable defining the maximum look-ahead timeframe and the variable defining the periodic basis into memory associated with the specialized computing device. The specialized computing device utilizes the plurality of variables indicating action history and transactions associated with the monitored account, the variable defining the maximum look-ahead timeframe, and the variable defining the periodic basis to derive one or more risk models associated with the monitored account. The one or more risk models describe risk associated with the monitored account according to the periodic basis up to the maximum look-ahead timeframe. The specialized computing device determines a risk level associated with the customer utilizing the one or more derived risk models. The one or more derived risk models and the determined risk level associated with the customer are utilized to generate a risk-driven campaign optimization strategy with the specialized computing device, considering the portfolio of monitored accounts. In an embodiment of the invention, the one or more communication channels comprise at least two communication channels and the risk-driven campaign optimization strategy is defined by an equation:

$${max}_{a} {\sum }_{j = 1}^{k} {\sum }_{i = 1}^{n} {a}_{ijt} ( {e}^{- ( {μ}_{j} {N}_{ijt} )} {l}_{i} {r}_{i} ( 1 - {e}^{- {B}_{j} {ϕ}_{i} ( t ) h ( ∇ {t}_{i}^{j} )} ) - {C}_{j} )$$

$$s . t . {\sum }_{i = 1}^{n} {a}_{ij} < {N}_{j} ∀ j$$

$${\sum }_{j = 1}^{k} {a}_{ij} = 1 ∀ i$$

$${a}_{ijt} ∈ \{ 0 , 1 \}$$

In an alternate embodiment, the risk-driven campaign optimization strategy comprises at least two sub-modules relating to single and multi-channel communications. The risk-driven campaign optimization strategy may be risk of delinquency reduction, cost optimization, and/or targeting.

The specialized computing device is utilized to generate a solution maximizing advantage considering the risk-driven campaign optimization strategy, the solution maximizing advantage including making a determination of whether to contact the customer, and, if so, determining which communication channel to utilize from the one or more communication channels to contact the customer, as well as determining a time t to contact the customer. In a further embodiment of the invention, when generating the solution maximizing advantage to the campaign optimization problem the specialized computing device factors the one or more derived risk models regarding one or more monitored accounts of the portfolio of monitored accounts to determine whether to contact the customer and which communications channel of the one or more communications channels to utilize to contact the customer.

If the specialized computing device determines a time t to contact the customer, the customer is contacted at time t utilizing the determined communication channel requesting at least a partial repayment of a loan associated with the monitored account. The specialized computing device may further receive and store into memory associated with the specialized computing device a time elapsed since a previous communication, a customer contact time preference factor, and a limiting factor limiting the number of communications sent to the customer, and utilize the time elapsed, the preference factor, and the limiting factor in generating the solution to the risk-driven campaign optimization strategy and making the determination whether to contact the customer.

In a further embodiment of the invention, the specialized computing device further determines a level of sensitivity the customer has to communications regarding the account and utilizes the determined level of sensitivity to determine whether to contact the customer at time t. Profits from contacting all customers associated with the portfolio of monitored accounts may be described by a formula, profit=Σₜ₌₁^{T}Σᵢ₌₁ⁿaᵢⱼₜpᵢⱼₜ. The risk-driven campaign optimization strategy may be defined by an equation:

$${max}_{a} {\sum }_{i = 1}^{n} {a}_{it} ( {e}^{- {N}_{i τ}} {l}_{i} {r}_{i} ( 1 - {e}^{- {ϕ}_{i} ( t ) h ( ∇ {t}_{i}^{c} )} ) - {C}_{c} )$$

$$s . t . {\sum }_{i = 1}^{n} {a}_{i} < {N}_{c}$$

$${a}_{it} ∈ \{ 0 , 1 \} .$$

The goal of the invention is to recover a loan amount, reduce an initial loss, or reduce in some other way the cost of providing an account to an individual by communicating with the customer in the optimal way (i.e., considering the user given parameters and resource constraints). A communication made via a communications channel of one or more communications channels available has an inherent cost, but also provides inherent profit by actually recovering an amount from a customer. Profit is defined as from customer i with communication channel j at time t. The inherent profit equals pᵢⱼₜ. The inherent cost is Cⱼ. Profit (from a communication involving a single communications channel)=Σₜ₌₁^{T}Σᵢ₌₁ⁿaᵢₜpᵢₜ.

The specific benefits of the invention including the receipt of strategic decision making by a specialized computing device for a contact center, allowing planning and execution of a multi-channel communications campaign. Such a campaign provides the maximum benefit when contacting customers by saving money from not making unnecessary communications or using overly expensive communications channels. The invention operates by taking into account the risk or behavioral propensity of each individual, therefore strategically planning in a unique way for each individual and for all the individuals together.

An embodiment of invention takes into account characteristics of the communication channel (costs, resources needed, etc.) and sequencing different kinds of communication (whether it is acceptable to follow-up communication using the same medium or not). An online simulation tool verifies the allocation of resources, and associated costs and visualization tools show the predicted effectiveness of a campaign. An embodiment of the invention, as further discussed here, proposes four different factors that are critical to the multi-channel action planning strategy, and a way to perform sensitivity analysis around these factors. Two problem formulations are proposed, based on these factors, and methods disclosed herein solve these formulations.

Note also, methods, systems, and apparatuses outlined in this invention allow dynamic planning for optimal action strategy in a single channel and multiple channel communication settings. A graphical display provides for the visualization of predicted optimal regimes of operation under various assumptions. Computational complexity for finding optimal regimes in an embodiment of the invention is O(nk log nk), where n is the number of customers and k is the number of channels. Every customer in a population and/or sub-group may be planned for, while taking into consideration the effectiveness of different means of communicating. Multiple different loading strategies are considered in the presently disclosed invention. Loading strategies, in an embodiment of the invention, are mathematical implementations of strategies which indicate a time or multiple time segments for which one or more communications are preferentially scheduled by the specialized computing device in a long service period between an account owner and account servicer. Also disclosed is an online mechanism including a simulation strategy, providing the optimal operational parameters under different loading strategies.

These and other aspects, objectives, features, and advantages of the disclosed technologies will become apparent from the following detailed description of illustrative embodiments thereof, which is to be read in connection with the accompanying drawings.

### BRIEF DESCRIPTION OF THE DRAWINGS

FIG. 1 is a flowchart displaying a process of execution of an embodiment of the invention.

FIG. 2 is a chart displaying evolution of risk or behavioral propensity over the life of two loan accounts, in an embodiment of the invention.

FIG. 3 is a diagram displaying is a multi-user planning horizon, including results of determinations if and, if so, when to utilize a communications channel of two (or more) communications channels to contact a customer to perform account-related pending actions, in an embodiment of the invention.

FIG. 4 is a chart displaying risk profile versus call threshold considering a constant strategy, in an embodiment of the invention.

FIG. 5 is a chart displaying results of utilization of a back loading strategy, in an embodiment of the invention.

FIG. 6 is a chart displaying results of utilization of a front loading strategy, in an embodiment of the invention.

FIG. 7 is a graph displaying how benefit varies versus call and e-mail thresholds, in an embodiment of the invention.

FIG. 8 is a series of graphs displaying benefit versus call and e-mail thresholds while changing risk profiles, in an embodiment of the invention.

FIG. 9 is a series of graphs displaying benefit versus call and e-mail thresholds while fixing risk profiles, in an embodiment of the invention.

### DETAILED DESCRIPTION

Describing now in further detail these exemplary embodiments with reference to the figures as described above, the system, method, and apparatus for Efficient Methods for Predictive Action Strategy Optimization for Risk Driven Multi-Channel Communication is described below. It should be noted that the drawings are not to scale.

As used herein, a “communication channel” is defined as any manner of contacting a customer from a contact center or elsewhere. Examples of communication channels include telephone calls, e-mails, web-chats, instant messages, messages transmitted or posted via social media (e.g. Facebook®), text messages, facsimiles, letters, or any other presently existing or after-arising equivalent or equivalents allowing contact with a customer. A “communication” is of the type standard (as one of skill in the art would know) and utilized in connection with the above-discussed communication channels. In the presently disclosed invention, there is a non-zero cost for the use of a communication channel for transmitting one or more communications to an individual or group of individuals.

As used herein, certain variables are defined as follows. Variable index “i” denotes a customer. Variable “lᵢ” denotes a loan/liability value/account amount owed by a customer i. For simplicity, assume only one loan/liability value/account is assigned to one customer, but a formulation in an embodiment of the invention may be extended to multiple loans per customer, if desired. There are a total of “n” customers. Each loan/liability value/account has some risk associated with it, and the risk associated with each loan/liability value/account is denoted as rᵢ, (i.e., the risk that the customer will not pay back the loan or the amount due on an account). For a given loan/liability value/account and risk profile, the initial loss to the lender is lᵢrᵢ, assuming that no action is taken. A communication with a customer takes place at time T. The communication channel utilized is denoted with index j. Binary variable aᵢⱼₜε{0,1} denotes whether a customer i is contacted via communication channel j at time t or not. In an embodiment of the invention, aᵢⱼₜ=1 indicates that customer is contacted at time t, while aᵢⱼₜ=0 indicates the customer was not contacted at time t. Let variable Nᵢⱼₜ be the number of communications that are performed with customer i using communication channel j at time interval T. Whenever a communication takes place, the inherent profit from the communication is defined as pᵢⱼₜ, the profit from customer i with channel j at time t. Finally, note that there is always cost associated with making a communication, defined as Cⱼ. It is assumed herein that cost is constant and unchanging. In the context of the presently disclosed invention, “loan,” “liability value,” and “account amount” are used interchangeably.

An “account” (within the context of this and associated patent applications) is a record of debt (typically, debt issued for or resulting from a specific purpose such as a payment for school tuition, mortgaging or refinancing a house, purchasing an automobile, payments for medical/dental services rendered, payments for utility services, paying off a credit card, payments for goods and/or services from a merchant, upcoming medical screening or vaccination scheduling, etc.), although any necessary repayment of debt qualifies. Accounts may have zero or more “financial transactions” associated with them, financial transactions including but not limited to issuance of the associated debt, payments made and applied, credits applied, late charges issued, monthly interest compounded, etc. The “action history” associated with an account is a history of financial transactions, including initial account amounts, payments made, dates associated with payments, payments missed, late charges charged, late charges paid, late charges waived, etc. An account contains one or more of the following (depending on the nature and particulars of the account): principal amount, interest rate, terms of repayment, date(s) of repayment made, date(s) of required payment(s), date(s) of missed payment(s), amount of required payment(s), date(s) of service rendered, etc. As discussed within, this patent application and associated patent applications, an account and an associated account history exist in a format accessible to a specialized computing device for processing such as a spreadsheet, .csv value, matrix (as defined by programming languages utilizing matrices), an array, a database entry, a linked-list, a tree-structure, other types of computer files or variables (or any other presently existing or after-arising equivalent). Variables tracked include (if appropriate), but are not limited to, the origination/initiation date of the account, dates of goods/services provided, the original amount of the account balance, the remaining principle balance to be paid, the date(s) of the payment(s) made, date(s) of payment(s) due, the current interest rate, the terms of repayment, total number of original monthly payment(s), number of remaining monthly payment(s), whether each monthly payment was timely (true/false), number day(s) delinquent of every monthly payment (from 0-integer), credit score of account holder at various points in time, original goods/services provided, etc. In a further embodiment of the invention, variables further include account status (is) (current or not), delinquency day(s) (dd), and forbearance month(s) (fm).

A “specialized computing device,” as discussed in the context of this patent application and related patent applications, refers to one or multiple computer processors acting together, a logic device or devices, an embedded system or systems, or any other device or devices allowing for programming and decision making. The specialized computing device discussed herein may manage a “contact center,” as further discussed below. Multiple computer systems with associated specialized computing devices may also be networked together in a local-area network or via the internet to perform the same function, and are therefore also a “specialized computing device” for the reasons discussed herein. In one embodiment, a specialized computing device may be multiple processors or circuitry performing discrete tasks in communication with each other. The system, method, and apparatus described herein are implemented in various embodiments as, to execute on a “specialized computing device[s],” or, as is commonly known in the art, such a device specially programmed in order to perform a task at hand. A specialized computing device is a necessary element to process the large amount of data (i.e. thousands, tens of thousands, hundreds of thousands, or more of accounts and account histories). Furthermore, the present invention may take the form of a computer program product embodied in any tangible medium of expression having computer usable program code embodied in the medium. Computer program code for carrying out operations of the present invention may operate on any or all of the “specialized computing device,” and/or a “server,” “computing device,” “computer device,” or “system” discussed herein. Computer program code for carrying out operations of the present invention may be written in any combination of one or more programming languages, including an object-oriented programming language such as Java, Smalltalk, C++, or the like, conventional procedural programming languages, such as Visual Basic, “C,” or similar programming languages. After-arising programming languages are contemplated as well.

A “contact center,” as discussed in the context of this patent application and related patent applications, refers to a facility, group of facilities, or other physical arrangement to manage customer contact using any and/or all of the communication channels as further discussed herein for a business, company, charity, or any other organization of individuals. A “call center” is an example of a type of contact center which focuses on utilization of telephones to contact customers.

With regard to certain notations and variables as used herein, note the following: elapsed time is denoted ∇t^{c}, with c denoting a call. Elapsed time is the elapsed time since a last call. It is based on an observation that the more time has elapsed from the last call, the more effective the current call is, but note elapsed time should not be so much that the customer forgets the previous call. The elapsed time since the last contact is considered directly, i.e. that effectiveness of the call is exponentially increasing as a function of elapsed time. The elapsed time since the last call may also be measured as an inequality, and should not be so high as to allow the customer to forget the previous call. If the time difference is too high, the customer is not contacted enough times over a time-span. ∇t^{c}=t−tᵢ^{c}, where t is the current time and while tᵢ^{c} is the time when the last call was made to customer i. The loading factor is denoted with φᵢ(t). The loading factor determines how and generally when different customers are contacted. Some customers prefer to be called in the early phase of default (front loading), while other customers prefer to be called in the latter phase of default (back loading). The loading factor plays a role in determining how and when a customer is contacted, in an embodiment of the invention. The loading factor is a function of time which denotes how to discount the elapsed time as the time progresses. The preference factor is denoted by Bⱼ. The preference factor is based upon the presumption that not all communication channels get the same preference from customers themselves. Some communication channels are preferred over others, e.g. e-mails are preferred over calls, etc. The preference factor acts similar to the loading factor, in that it increases or decreases the effective elapsed time between contacts. Unlike the loading factor, the preference factor remains constant with respect to time, and only changes as based upon the communication channel. In an embodiment, the preference factor changes with each customer, but in a simplified embodiment the preference factor is assumed to be the same for all customers. The limiting factor is denoted using variable γ_{ijτ}. The limiting factor limits the number of communications that may be sent to a customer. In practice, one cannot call or send e-mails indefinitely to a customer because after a certain time, the effect of the e-mail or call diminishes, i.e. after a certain time, the customer would not pay the money back, no matter how many times he/she is contacted. This limiting factor precisely models that. The benefit from any single call typically reduces as the number of calls increases. This is modelled by an exponential term. The limiting factor depends on the number of communications made to a customer so far, so if N_{ijτ} is the number of communications made until time interval τ, i.e. e^{-μ}^{ⱼ}^{N}^{_{ijτ}} is the limiting factor. Here the interval is defined from the beginning of the time i.e. τ=t−0. The μⱼ term depends on the preference factor and models the rate of the exponential function. This means that it is desirable to send more e-mails that calls. Note that while the preference factor is related to the limiting factor (with μⱼ), the preference factor models that one communication is preferred when communicating while the limiting factor models, by means of non-limiting example, that it is acceptable to send more e-mails while it is not acceptable to send more calls.

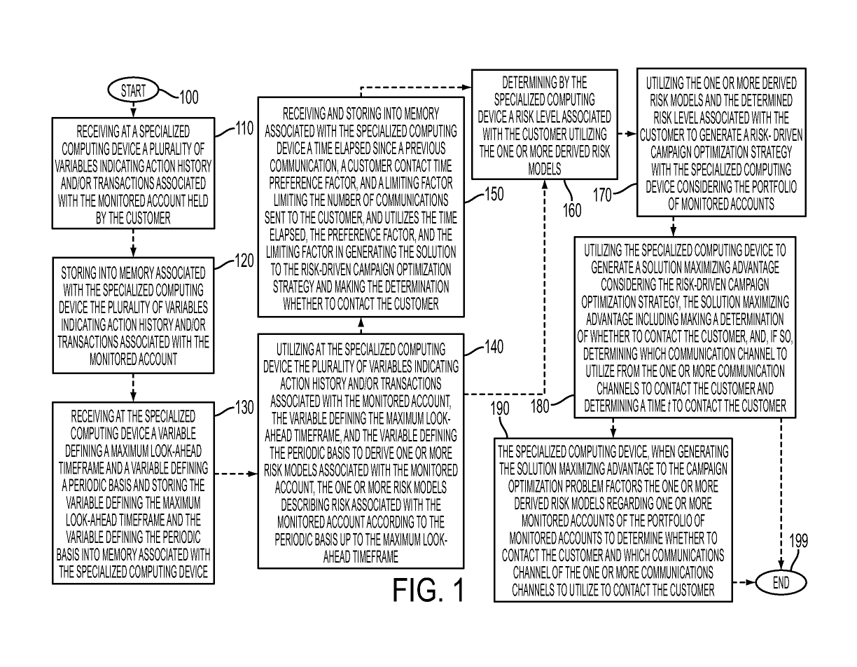

Referring to FIG. 1, displayed is a flowchart displaying a process of execution of an embodiment of the invention. Execution begins at step 100. At step 110 a specialized computing device receives a plurality of variables indicating action history and/or transactions associated with the monitored account held by the customer. At step 120 the plurality of variables indicating action history and/or transactions associated with the monitored account are stored into memory associated with the specialized computing device. At step 130 the specialized computing device receives a variable defining a maximum look-ahead timeframe and a variable defining a periodic basis and stores the variable defining the maximum look-ahead timeframe and the variable defining the periodic basis into memory associated with the specialized computing device. At step 140 the specialized computing device utilizes the plurality of variables indicating action history and/or transactions associated with the monitored account, the variable defining the maximum look-ahead timeframe, and the variable defining the periodic basis to derive one or more risk models associated with the monitored account, the one or more risk models describing risk associated with the monitored account according to the periodic basis up to the maximum look-ahead timeframe. At step 150 the specialized computing device receives and stores into memory associated with the specialized computing device a time elapsed since a previous communication, a customer contact time preference factor, and a limiting factor, limiting the number of communications sent to the customer, and utilizes the time elapsed since the previous communication, the customer contact time preference factor, and the limiting factor in generating the solution to the risk-driven campaign optimization strategy and making the determination whether to contact the customer. At step 160 the specialized computing device determines a risk level associated with the customer utilizing the one or more derived risk models. At step 170, the specialized computing device utilizes the one or more derived risk models and the determined risk level associated with the customer to generate a risk-driven campaign optimization strategy with the specialized computing device considering the entire portfolio of monitored accounts. In an embodiment, there are two general ways that the risk-driven campaign optimization strategy is formulated. The first general way is utilized when the specialized computing device managing the contact center is interested in determining the assignment at each time step, i.e. for each time step t, the specialized computing device managing the contact center desires to determine the assignments given the assignment variables until t−1. The second general way involves getting all assignments at the same time until the end of time interval T.

Considering the above factors, in an embodiment of the invention the effectiveness of a call fᵢₜ (or other communication) is modelled in the following way (for only one channel):

$$\begin{matrix}{f}_{it} = {γ}_{i τ} ( 1 - {e}^{- {ϕ}_{i} ( t ) h ( ∇ {t}_{i}^{c} )} ) \\ = {e}^{- {N}_{i τ}} ( 1 - {e}^{- {ϕ}_{i} ( t ) h ( ∇ {t}_{i}^{c} )} )\end{matrix}$$

Also considering the above factors, in a further embodiment of the invention, for multiple channels the function is written by including an index for channel, i.e. j:

$$\begin{matrix}{f}_{ijt} = {γ}_{ij τ} ( 1 - {e}^{- {B}_{j} {ϕ}_{i} ( t ) h ( ∇ {t}_{i}^{j} )} ) \\ = {e}^{- ( {μ}_{j} {N}_{ij τ} )} ( 1 - {e}^{- {B}_{j} {ϕ}_{i} ( t ) h ( ∇ {t}_{i}^{j} )} )\end{matrix}$$

The first general way of determining assignments given the assignment variables is focused upon here. For the case when there is only one channel, the optimization problem, by considering one time step at a time, is written as follows:

$${max}_{a} {\sum }_{i = 1}^{n} {a}_{it} ( {e}^{- {N}_{i τ}} {l}_{i} {r}_{i} ( 1 - {e}^{- {ϕ}_{i} ( t ) h ( ∇ {t}_{i}^{c} )} ) - {C}_{c} )$$

$$s . t . {\sum }_{i = 1}^{n} {a}_{i} < {N}_{c}$$

$${a}_{it} ∈ \{ 0 , 1 \} .$$

(where N_{c} is the capacity constraint i.e. the number of calls that a contact center may handle at any given time).

The algorithm to solve the above optimization problem, Algorithm 1, is provided below, and is based on sorting of scores. In each time step, scores are computed for all customers (by considering the times difference from the previous time the customers were called) and then these scores are sorted. The score is, in effect, nothing but profit pᵢₜ. From the sorted list, the top N_{c} customers make their assignment variables 1. The assignment variables for the rest of the customers are set to 0. This process is repeated until the end of time T. The computational complexity of Algorithm 1 is O(Tn log n):

Algorithm 1: Algorithm for Solving
Single Channel Single Time Problem

Input: θ, lᵢ, rᵢ, ∀i
Output: Assigned value for aᵢ for each time step.
Initialize: Sort all users according to lᵢrᵢ. From the sorted list, for top N_{c}
users, set aᵢ = 1. For others, aᵢ = 0.
for t = 1 to T do

for i = 1 to n do

Compute ∇tᵢ^{c}
Compute the cost function via a computation of fᵢₜ

end for
S = sort all fᵢₜ
For top N_{c} users from the sorted list S, set aᵢ = 1, for others aᵢ = 0

end for

Continuing, the above formulation may be extended for multiple channels by considering the channel index j, and the preference factor Bj. The objection function here is:

$${max}_{a} {\sum }_{j = 1}^{k} {\sum }_{i = 1}^{n} {a}_{ijt} ( {e}^{- ( {μ}_{j} {N}_{ijt} )} {l}_{i} {r}_{i} ( 1 - {e}^{- {B}_{j} {ϕ}_{i} ( t ) h ( ∇ {t}_{i}^{j} )} ) - {C}_{j} )$$

$$s . t . {\sum }_{i = 1}^{n} {a}_{ij} < {N}_{j} ∀ j$$

$${\sum }_{j = 1}^{k} {a}_{ij} = 1 ∀ i$$

$${a}_{ijt} ∈ \{ 0 , 1 \}$$

(where μⱼ, as stated earlier, depends on the preference factor Bⱼ. Here, μⱼ is computed by first inverting Bⱼ, i.e. 1/Bⱼ, and then normalizing it.)

There are three constraints in the above optimization problem. The first constraint is the capacity constraint which is used because there are limitations on the number of communications that may be handled by a communication center at any given time. The second constraint is used to make sure that at any given time, a customer is only contacted using one channel. The third constraint is simply the binary constraint for the assignment variables.

The algorithm to solve the above optimization problem is provided below, Algorithm 2. This algorithm is similar to the previous algorithm, i.e. it is also based on sorting the scores. The score for all customers for all channels is computed here. This provides multiple lists of scores, each list belonging to one channel. These scores are sorted, combining all lists into a single list. The next step is to iterate over the combined list, and set the assignment variable corresponding to the score to 1. Continue iterating until the capacity of all channels is exhausted. The process is repeated until the end of the time T. The computational complexity of the Algorithm 2 is O(Tnk log(nk)), where k is the total number of channels.

Algorithm 2: Algorithm for Solving
Multi-Channel Single Time Problem

Input: η, function φᵢ(t), Bⱼ.
Output: Assigned value for aᵢⱼ for each time step.
Initialize: Sort all users according to lᵢrᵢ. From the sorted list, for top N_{c}
users, choose a random integer p ∈ {0, k} and aᵢ = k.
for t = 1 to T do

for i = 1 to n do

for j = 1 to k do
Compute ∇tᵢ^{j}
Compute the cost function via fᵢⱼₜ
end for

end for
S = sort all fᵢⱼₜ
Set counters πⱼ = 0, ∀j = 1 . . . k
while i = 1 to |S| and Sᵢ > 0 do

p ← j index corresponding to Sᵢ
if πₚ < N_{P} then

aᵢ = p
πₚ = πₚ + 1

end if

end while

end for

At step 180, the specialized computing device is utilized to generate a solution maximizing advantage considering the risk-driven campaign optimization strategy, the solution maximizing advantage including making a determination of whether to contact the customer, and, if so, determining which communication channel to utilize from the one or more communication channels to contact the customer and determining a time t to contact the customer. In effect, in determining whether to communicate with a customer at a particular time or not, the specialized computing device is determining the assignment of aᵢⱼₜ. Total profit from contacting all customers is described by an equation: profit=Σₜ₌₁^{T}Σᵢ₌₁ⁿaᵢⱼₜpᵢⱼₜ.

In an embodiment of the invention at step 180, only one communication channel is considered, and merely the time t is determined. In such an embodiment, variables discussed herein pᵢⱼₜ becomes pᵢₜ, aᵢⱼₜ becomes aᵢₜ, and so on. Index j may be replaced with c, where c stands for calls. The goal of a further embodiment of the invention is maximizing profits through communicating with customers. Total profit over a period of time is described by the equation: profit=Σₜ₌₁^{T}Σᵢ₌₁ⁿaᵢⱼₜpᵢⱼₜ, where pᵢₜ is the profit from one customer. If seeking maximization of profits, there are multiple ways that the profit term pᵢₜ may be modeled. One such example is in terms of the fraction of the initial amount (lᵢrᵢ) that a particular contact may be expected to return. The profit from all calls may be written profit=Σₜ₌₁^{T}Σᵢ₌₁ⁿaᵢₜlᵢrᵢfᵢₜ, where fᵢₜ is the fraction of the initial amount.

Considering the above, in an embodiment of the invention, as discussed previously, the effectiveness of a call fᵢₜ (or other communication) is modelled in the following way (for only one channel):

$$\begin{matrix}{f}_{it} = {γ}_{i τ} ( 1 - {e}^{- {ϕ}_{i} ( t ) h ( ∇ {t}_{i}^{c} )} ) \\ = {e}^{- {N}_{i τ}} ( 1 - {e}^{- {ϕ}_{i} ( t ) h ( ∇ {t}_{i}^{c} )} )\end{matrix}$$

Here h(.) is a step function i.e. h(∇tᵢ^{j})=1_{(∇t}_{ᵢ}_{ⁱ}_{>θ)}, where θ is the step threshold. The function 1_{(a>b)}=1 when a>b, otherwise 0. This function is used to make sure that there is definitely some reasonable time elapsed before the same communication channel is used again. This is the hard constraint as it is usually not advisable to contact the same customer in a very short time period even if the model suggests so. In the above cost function, it is important that fᵢₜ has two properties:
1. φᵢ(t)h(∇tᵢ^{c})→0 [symbol] fᵢₜ→0
2. φᵢ(t)∇tᵢ^{c}→∞ [symbol] fᵢₜ→1

This means that when the discounted time elapsed is 0, the communication is almost ineffective while if the time elapsed becomes very large, the communication would be very effective. Both of these constraints are satisfied by fᵢₜ. The above function is only for one single channel.

In a further embodiment of the invention, as discussed previously, for multiple channels the function is written by including an index for channel i.e. j:

$$\begin{matrix}{f}_{ijt} = {γ}_{ij τ} ( 1 - {e}^{- {B}_{j} {ϕ}_{i} ( t ) h ( ∇ {t}_{i}^{j} )} ) \\ = {e}^{- ( {μ}_{j} {N}_{ij τ} )} ( 1 - {e}^{- {B}_{j} {ϕ}_{i} ( t ) h ( ∇ {t}_{i}^{j} )} )\end{matrix}$$

Here ∇tᵢ^{j}=t−tᵢⁱ, with t being the current time, tᵢⁱ being the time when customer i was contacted by channel j. Notice the preference factor Bⱼ in the multiple channel function, which was not there in the simple channel function. Here, it is assumes that a loading strategy is given. In case the loading strategy is not given, it may be computed using other models (personalized behaviour model). For the sake of the presently disclosed invention, the following loading strategies are considered:

1. Uniform: φᵢ(t)=constant

2. Front Loading: φᵢ(t)=rᵢe^{τ}

3. Back Loading: φᵢ(t)=1−rᵢe^{τ}

Here τ=t−0 is the time interval from the beginning of the time.

After step 180, execution ends 199, or execution proceeds to step 190. At step 190 the specialized computing device, when generating the solution maximizing advantage to the campaign optimization problem factors the one or more derived risk models regarding one or more monitored accounts of the portfolio of monitored accounts to determine whether to contact the customer and which communications channel of the one or more communications channels to utilize to contact the customer. After step 190, execution terminates 199.

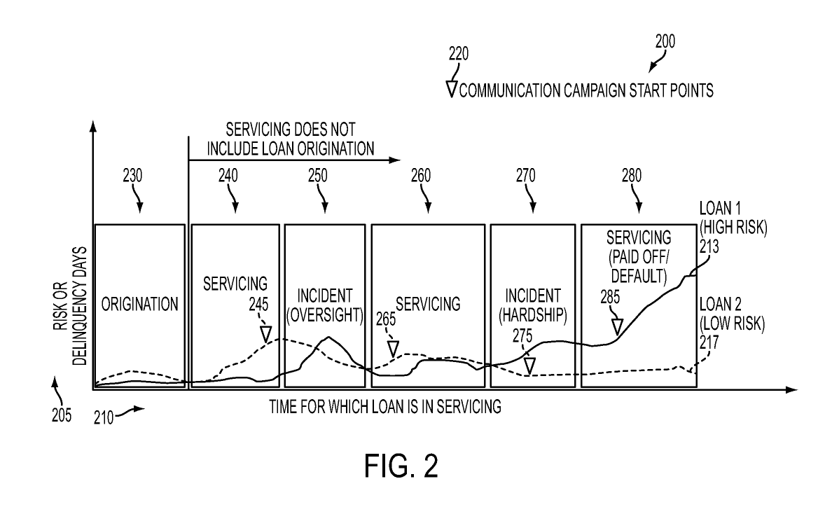

Referring to FIG. 2, displayed is a chart 200 displaying evolution of risk or behavioral propensity over the life of two loan accounts, in an embodiment of the invention. Although loan accounts are discussed with regard to FIG. 2, as mentioned previously, the invention may be extended to any type of account being serviced and a similar chart made. The risk associated with the loan accounts or number of days delinquent 205 is displayed on the y-axis. The time for which the loans are being serviced 210 is displayed on the x-axis. Two loans are displayed on the chart 200, one displaying indicia of high-risk 213 and one displaying indicia of low-risk 217. Arrows 220 display possible communication campaign start points. Loan accounts are initiated during an “origination” phase 230. Initial loan “servicing” 240 of the loan accounts then begins. As risk increases (or the number of days delinquent increases) with regard to the low risk loan account 217, at arrow 245 a communication channel may be utilized to contact a customer holding the loan 217. There is a phase during which an “incident” caused by simple “oversight” occurs at 250, but due to the internal workings of the presently disclosed invention, no contact is initiated during phase 250. Risk naturally decreases as payments are caught up with for both loans 213 and 217 towards the end of phase 250. Risk begins to increase again during servicing phase 260 for loans 213 and 217. At arrow 265 a contact may be initiated with regard to low risk loan account 217 via a communication channel. At arrow 275, during a time when risk begins to increase on the high-risk loan 213, a contact may be initiated. This is during an “incident” period caused by “hardship” 270. Another contact may be performed at arrow 285 during a “servicing” period when the loans are nearly “paid off” or in “default” 280. The contact which may take place at arrow 285 is with regard to high-risk loan 213.

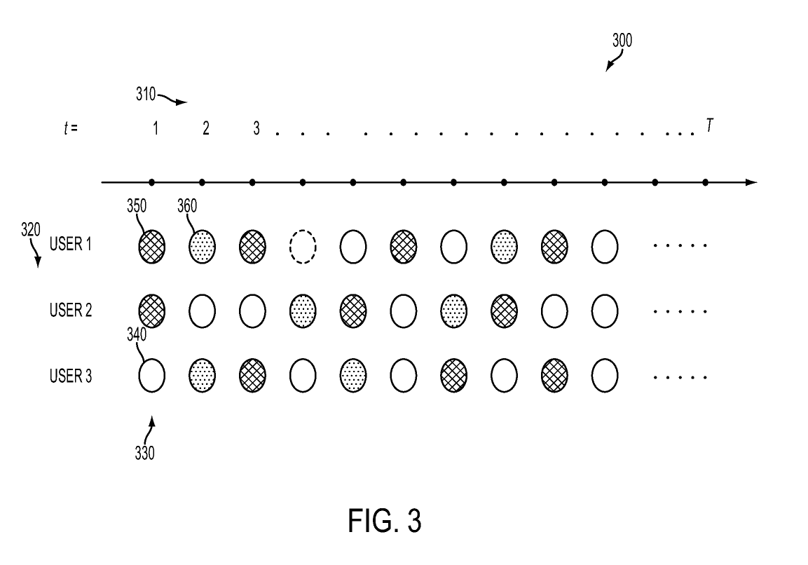

Referring to FIG. 3 is a diagram 300 displaying is a multi-user planning horizon, including results of determinations if and, if so, when to utilize a communications channel of two (or more) communications channels to contact a customer to perform account-related pending actions, in an embodiment of the invention. During the communication campaign, the entire user population and multiple communication channels, if present, (and their individual characteristics) are considered. The time t when an action is or is not performed is displayed on the x-axis 310. Each user/customer is considered and displayed on the y-axis 320. For simplification, three users/customers are displayed on FIG. 3. As shown at 330, at time t=1 and elsewhere in FIG. 3, a circle colored as 350 indicates a contact was made to the customer using a first communication channel. As shown at time t=2, a circle colored as 360 indicates a contact was made using a second communications channel. An empty circle (such as 340 at t=1) indicates no contact was attempted at time t. Generally, an optimal strategy is to determine by using the appropriate cost and benefit regarding a call, an allocation of communication resources via communication channels to different users at different times, formulating the appropriate campaign optimization strategy and designing an algorithm to solve it for the best allocation of such resources.

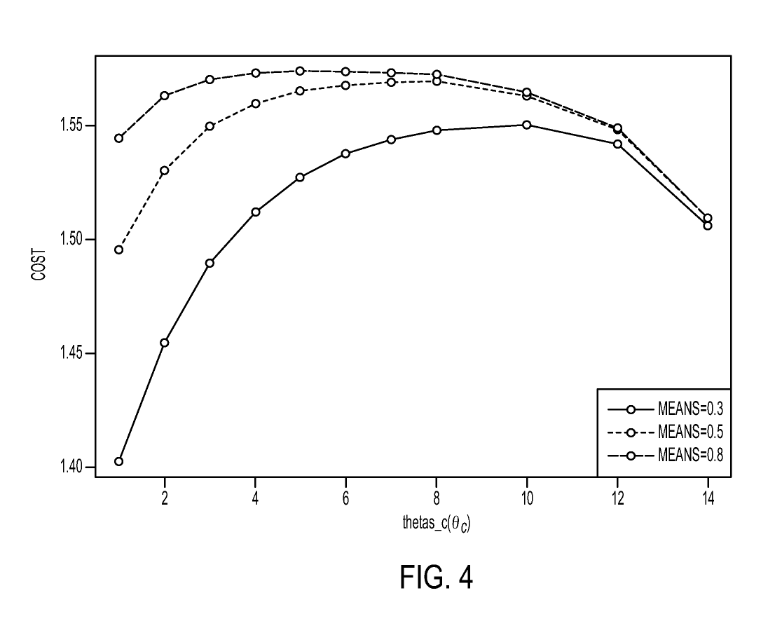

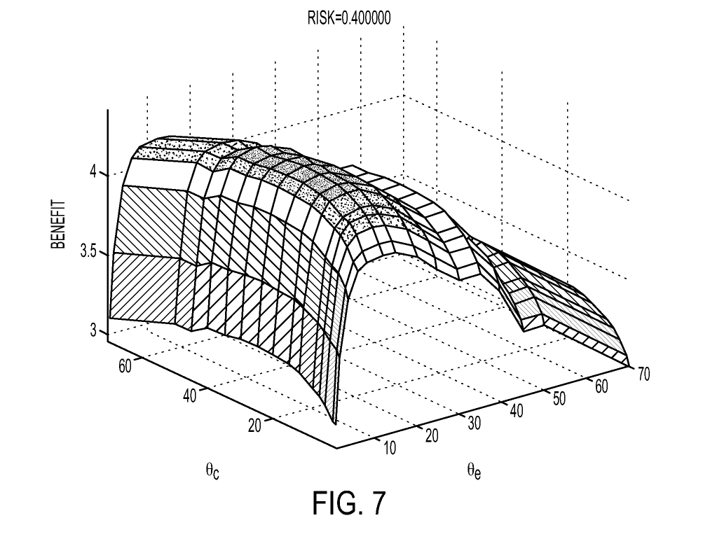

Referring generally to FIGS. 4-9, displayed are charts displaying results of experiments run utilizing embodiments of the proposed invention. Different scenarios are simulated considering different values for parameters discussed herein, such parameters including the preference factor Bⱼ, communication thresholds θⱼ, loading strategies, etc. For these scenarios, a solution is generated maximizing advantage considering the risk-driven campaign optimization strategy. Such simulations provide insight on optimal operational conditions for a given set of parameters. FIGS. 4-6 describe a single-channel setting, while FIGS. 7-9 describe a multi-channel setting.

Referring more specifically to FIGS. 4-6, displayed are charts generated during execution of a simulation of an embodiment of the invention considering only a single communication channel (calls) and different loading strategies. The solution is, correspondingly, regarding only a single communications channel. In the course of planning action strategy and generating a solution maximizing advantage considering the risk-driven campaign optimization strategy, first risk profiles are generated. Risk profiles are generated from a Gaussian distribution with mean mε(0,1) and variance σ=1. The higher variance denotes that there are only few borrowers which are very risky while others have low to moderate risk. A low variance means that borrowers in the same portfolio have more or less the same level of risk. It is assumed the cost of one call is $9 (C_{c}=$9), while the cost of sending one e-mail is $0.014 (Cₑ=$0.014).

Referring to FIG. 4, a chart displays a risk profile versus a call threshold considering a constant strategy, in an embodiment of the invention. In the simulation behind FIG. 4, the risk profile is fixed and communications threshold θ_{c} varies, seeking to understand how benefit changes as the communications threshold θ_{c} is changed. Benefit versus θ_{c} is plotted on FIG. 4 for three risk profiles with mean=(0.3, 0.5, 0.8) and variance 1 as shown in FIG. 4. The loading strategy utilized in FIG. 4 is the “constant strategy.” Two conclusions may be drawn from the resulting chart of FIG. 4: first, that there exists a value of θ_{c} that is optimal. A lower value of θ_{c} is related to call frequency, which is not necessarily a positive outcome. The second conclusion that may be drawn is that the optimal value of θ_{c} decreases as the risk increases. The conclusion to be drawn is that individuals with a high level of risk should be contacted frequently.

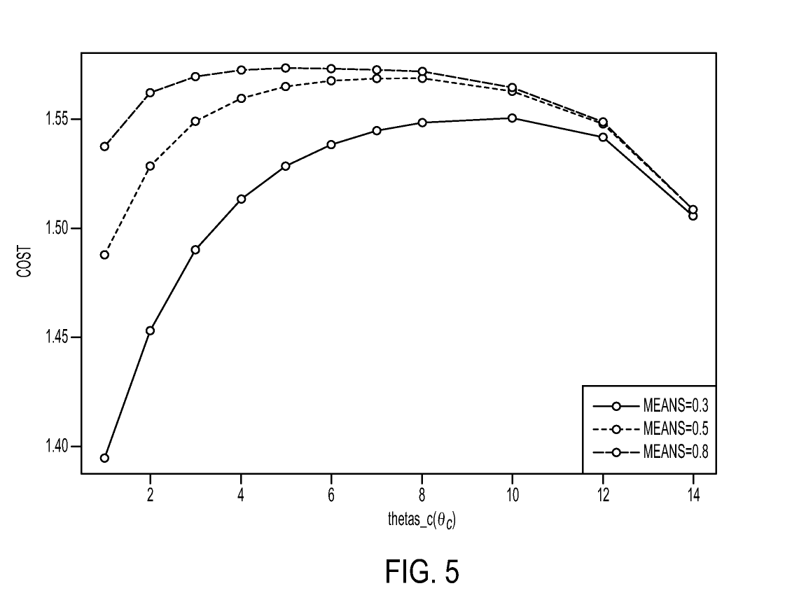

Referring to FIG. 5, displayed is a chart showing results of running other simulations in an embodiment of the invention, here specifically the results of utilizing a back loading strategy is displayed. FIG. 5 is functionally very similar to FIG. 4 (as above, displaying a constant loading strategy). This occurs because in the back loading strategy, placing calls in the early stage of default is discouraged to discount the time difference from the previous call more in the early phase than in the latter phase. This discount, however, is not enough to counter the effects of a limiting factor, γ. The limiting factor γ factor is used, so it is not possible to make an indefinite number of calls to a customer. As time increases, the number of calls increases and decreases the benefit exponentially. This reduction dominates over the advantage given by the loading factor, providing effect similar to the constant loading strategy.

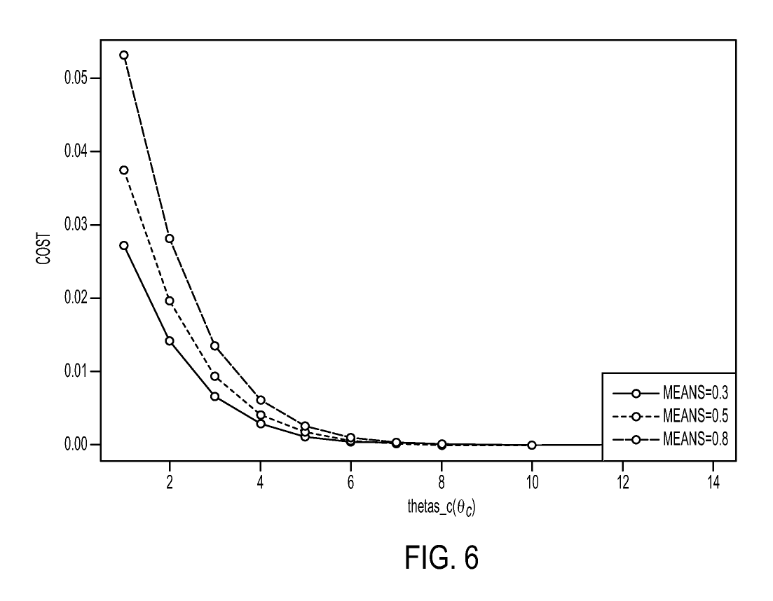

Referring to FIG. 6, displayed is the results of utilizing a front loading strategy, in an embodiment of the invention. It is visible in FIG. 6 that the optimal point of threshold occurs at the very beginning, and as the threshold increases, the benefit goes down, as makes sense intuitively. Recall that as limiting factor γ-allows only a certain number of calls, if these calls are restricted to only being made in an early phase of default, it is better to make these calls frequently, given that each call provides a positive benefit, and the sheer volume of calls made may be beneficial.

Referring to FIGS. 7-9, displayed are charts displaying risk profile versus call thresholds during execution of a simulation of an embodiment of the invention considering multiple communication channels. Two channels are considered, phone calls and e-mails, although as noted previously any number of communication channels may be considered. Each channel has its own communication threshold, denoted by θ_{c} and θₑ, respectively. For multiple communication channel experiments, the loading strategy is fixed (i.e. constant), and experiments may be conducted in the simulation by variables such as risk, preference factor, etc. How benefit changes with respect to θ_{c} and θₑ may be seen. The risk profile is varied to understand how optimal θ_{c} and θₑ changes are made according to a different risk profile. Finally, the simulations shown in FIGS. 7-9 are useful for understanding the behaviour of the preference factor and the limiting factor on the optimal values of θ_{c} and θₑ.

Referring to FIG. 7, displayed is a graph showing how benefit varies versus the call and e-mail thresholds, θ_{c} and θₑ, respectively, which serves to provide insight into operation of a contact center. FIG. 7 is generated for fixed risk=0.2 and for a fixed preference ratio, i.e. ρ=2. Here, the preference ratio is defined as

$$ρ = \frac{{B}_{e}}{{B}_{c}} .$$

Note that the optimal point of this plot displayed in FIG. 7 occurs at (θ_{c}, θₑ)=(25, 12). The large difference in these thresholds occurs because of most customers' general preference for e-mails over calls, and this preference is modeled using the preference factor and limiting factor. This difference increases as the ratio ρ increases. For a given risk profile, this indicates e-mails are sent more frequently than calls. It is also important to note that the variation of benefit with respect to θₑ is much higher than with respect to θ_{c}. This occurs because the simulation only allows a limited number of calls and e-mails to be sent to a customer (the exponential term in the front of the cost function is denoted by a limiting factor, γ). Because of this, the number of calls does not change as θ_{c} changes, while the number of e-mails does change with changes in θₑ. When θ_{c} changes, a high θ_{c} means a fixed number of calls are sent later in the time period, while a low θ_{c} means that the calls are sent in the early phase, though the number of calls are almost the same which is why the change is not much. This change occurs not because of the number of calls but rather when the calls are made. On the other hand, benefit varies with respect to θₑ because of the change in the number of e-mails sent.

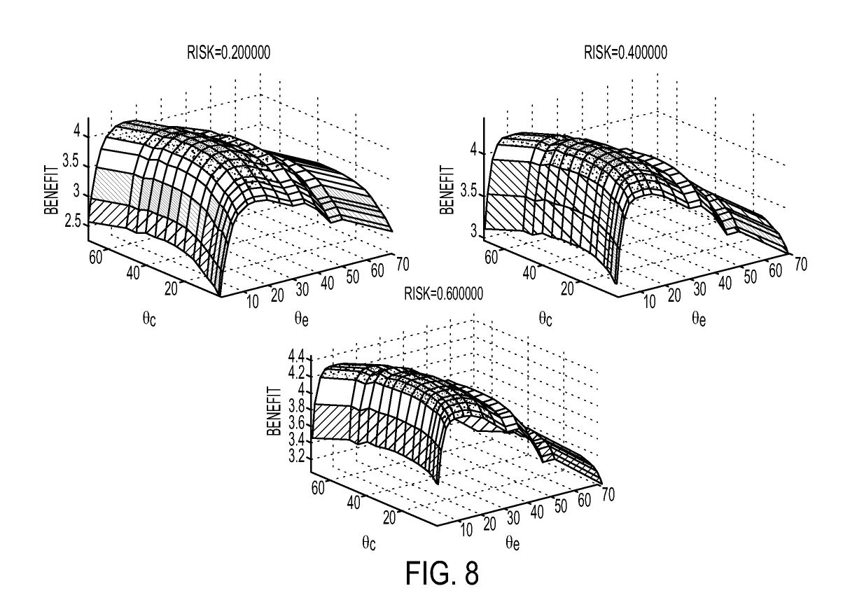

Referring now to FIG. 8, displayed are a series of graphs displaying benefit versus call and e-mail thresholds, θ_{c} and θₑ, respectively, while changing risk profiles in an embodiment of the invention. FIG. 8 plots the optimal curves with respect to θ_{c} and θₑ for different risk profiles, i.e., risks=0.2, 0.4, and 0.6., providing insight as to how the optimal points change as the risk profile changes. The optimal point for the risk profile occurs at (30,15), (25,12), and (20,8), respectively. As risk increases, both θ_{c} and θₑ go down. This indicates that as risk increases, it is necessary to become more aggressive in campaigning (i.e. calling and sending e-mails more frequently).

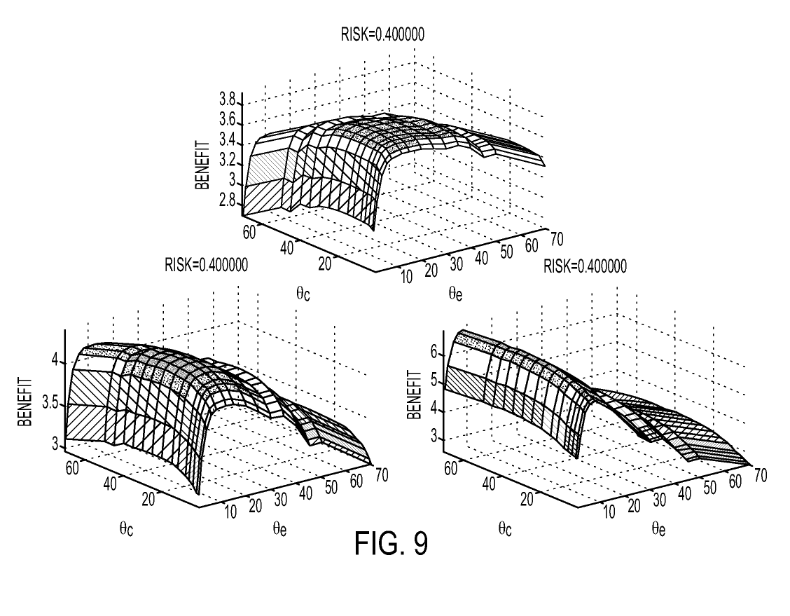

Referring now to FIG. 9, displayed are a series of graphs displaying benefit versus call and e-mail thresholds, θ_{c} and θₑ while fixing risk profiles at 0.4, and changing the ratio ρ in an embodiment of the invention. FIG. 9 shows how the optimal point changes as preference for one channel over another channel increases. In FIG. 9, three different ratios are discussed, i.e. for p=1, 2, and 5, for which the optimal point occurs at (θ_{c},θₑ)=(20,15) (25,12), (40,8) respectively. From FIG. 8 it may be determined that as the ratio preference θ_{c} increases θₑ decreases. This corresponds with general intuition that higher preference for e-mails means sending more frequent e-mails than calls.

The preceding description has been presented only to illustrate and describe the invention. It is not intended to be exhaustive or to limit the invention to any precise form disclosed. Many modifications and variations are possible in light of the above teachings.

As will be appreciated by one of skill in the art, the presently disclosed invention is intended to comply with all relevant local, city, state, federal, and international rules regarding the collection of debts, and otherwise.

The preferred embodiments were chosen and described in order to best explain the principles of the invention and its practical application. The preceding description is intended to enable others skilled in the art to best utilize the invention in its various embodiments and with various modifications as are suited to the particular use contemplated. It is intended that the scope of the invention be defined by the following claims.

What is claimed is:

1. A method of utilizing a specialized computing device managing a contact center to analyze and reduce future financial risk on a portfolio of monitored accounts via a determination of whether or not and, if so, when to utilize a communications channel of one or more communication channels available to contact a customer regarding a monitored account in the portfolio of monitored accounts, seeking to maximize advantage from contacting the customer to perform account-related pending actions while minimizing costs associated with contacting the customer, said method comprising:
Receiving at the specialized computing device a plurality of variables indicating action history and transactions associated with the monitored account held by the customer;
Storing into memory associated with the specialized computing device the plurality of variables indicating action history and transactions associated with the monitored account;
Receiving at the specialized computing device a variable defining a maximum look-ahead timeframe and a variable defining a periodic basis and storing the variable defining the maximum look-ahead timeframe and the variable defining the periodic basis into memory associated with the specialized computing device;
Utilizing at the specialized computing device the plurality of variables indicating action history and transactions associated with the monitored account, the variable defining the maximum look-ahead timeframe, and the variable defining the periodic basis to derive one or more risk models associated with the monitored account, the one or more risk models describing risk associated with the monitored account according to the periodic basis up to the maximum look-ahead timeframe;
Determining by the specialized computing device a risk level associated with the customer utilizing the one or more derived risk models;
Utilizing the one or more derived risk models and the determined risk level associated with the customer to generate a risk-driven campaign optimization strategy with the specialized computing device considering the portfolio of monitored accounts; and
Utilizing the specialized computing device to generate a solution maximizing advantage considering the risk-driven campaign optimization strategy, the solution maximizing advantage including making a determination of whether to contact the customer, and, if so, determining which communication channel to utilize from the one or more communication channels to contact the customer and determining a time t to contact the customer.

2. The method of claim 1, wherein if the determination is made to contact the customer at time t, the customer is contacted at time t utilizing the determined communication channel requesting at least a partial repayment of a loan associated with the monitored account.

3. The method of claim 2, wherein the specialized computing device further receives and stores into memory associated with the specialized computing device a time elapsed since a previous communication, a customer contact time preference factor, and a limiting factor limiting the number of communications sent to the customer, and utilizes the time elapsed, the preference factor, and the limiting factor in generating the solution to the risk-driven campaign optimization strategy and making the determination whether to contact the customer.

4. The method of claim 1, further comprising determining via the specialized computing device a level of sensitivity the customer has to communications regarding the account and utilizing the determined level of sensitivity to determine whether to contact the customer at time t.

5. The method of claim 1, wherein profits from contacting all customers associated with the portfolio of monitored accounts is described by a formula, profit=Σₜ₌₁^{T}Σᵢ₌₁ⁿaᵢⱼₜpᵢⱼₜ.

6. The method of claim 5, wherein the risk-driven campaign optimization strategy is defined by an equation:
$${max}_{a} {\sum }_{i = 1}^{n} {a}_{it} ( {e}^{- {N}_{i τ}} {l}_{i} {r}_{i} ( 1 - {e}^{- {ϕ}_{i} ( t ) h ( ∇ {t}_{i}^{c} )} ) - {C}_{c} )$$
$$s . t . {\sum }_{i = 1}^{n} {a}_{i} < {N}_{c}$$
$${a}_{it} ∈ \{ 0 , 1 \} .$$

7. The method of claim 5, wherein the one or more communication channels comprise at least two communication channels and the risk-driven campaign optimization strategy is defined by an equation:
$${max}_{a} {\sum }_{j = 1}^{k} {\sum }_{i = 1}^{n} {a}_{ijt} ( {e}^{- ( {μ}_{j} {N}_{ijt} )} {l}_{i} {r}_{i} ( 1 - {e}^{- {B}_{j} {ϕ}_{i} ( t ) h ( ∇ {t}_{i}^{j} )} ) - {C}_{j} )$$
$$s . t . {\sum }_{i = 1}^{n} {a}_{ij} < {N}_{j} ∀ j$$
$${\sum }_{j = 1}^{k} {a}_{ij} = 1 ∀ i$$
$${a}_{ijt} ∈ \{ 0 , 1 \} .$$

8. The method of claim 1, wherein the risk-driven campaign optimization strategy comprises at least two sub-modules relating to single and multi-channel communications.

9. The method of claim 1, wherein one or more communication channels comprise one or more of telephone calls, e-mails, text messages, web-chats, and social media messages.

10. The method of claim 1, wherein the portfolio of monitored accounts comprise selectively one of more of the following: loans, insurance claims, pending bills/liabilities, and medical/health actions.

11. The method of claim 1, wherein the campaign optimization strategy is selectively one of the following: risk of delinquency reduction, cost optimization, and targeting.

12. The method of claim 1, wherein when generating the solution maximizing advantage to the campaign optimization problem the specialized computing device factors the one or more derived risk models regarding one or more monitored accounts of the portfolio of monitored accounts to determine whether to contact the customer and which communications channel of the one or more communications channels to utilize to contact the customer.

13. A system using a specialized computing device managing a contact center to analyze and reduce future financial risk on a portfolio of monitored accounts via a determination of whether or not and, if so, when to utilize a communications channel of one or more communication channels available to contact a customer regarding a monitored account in the portfolio of monitored accounts, seeking to maximize advantage from contacting the customer to perform account-related pending actions while minimizing costs associated with contacting the customer, the system comprising:
The specialized computing device receives a plurality of variables indicating action history and transactions associated with the monitored account held by the customer;
Memory associated with the specialized computing device stores the plurality of variables indicating action history and transactions associated with the monitored account;
The specialized computing device receives a variable defining a maximum look-ahead timeframe and a variable defining a periodic basis and storing the variable defining the maximum look-ahead timeframe and the variable defining the periodic basis into memory associated with the specialized computing device;
The specialized computing device utilizes the plurality of variables indicating action history and transactions associated with the monitored account, the variable defining the maximum look-ahead timeframe, and the variable defining the periodic basis to derive one or more risk models associated with the monitored account, the one or more risk models describing risk associated with the monitored account according to the periodic basis up to the maximum look-ahead timeframe;
The specialized computing device determines a risk level associated with the customer utilizing the one or more derived risk models and then utilizes the one or more derived risk models and the determined risk level to generate a risk-driven campaign optimization strategy considering the entire portfolio of monitored accounts; and
The specialized computing device generates a solution maximizing advantage considering the risk-driven campaign optimization strategy, the solution maximizing advantage including making a determination of whether to contact the customer, and, if so, determining which communication channel to utilize from the one or more communication channels and determining a time t to contact the customer.

14. The system of claim 13, wherein if the determination is made to contact the customer at time t, the customer is contacted at time t utilizing the determined communication channel requesting at least a partial repayment of a loan associated with the monitored account.

15. The system of claim 14, wherein the specialized computing device further receives and stores into associated memory a time elapsed since a previous communication, a customer contact time preference factor, and a limiting factor limiting the number of communications sent to the customer, and utilizes the time elapsed, the preference factor, and the limiting factor in generating the solution to the risk-driven campaign optimization strategy and making the determination whether to contact the customer.

16. The system of claim 13, wherein the specialized computing device determines a level of sensitivity the customer has to communications regarding the account and utilizes the determined level of sensitivity to determine whether to contact the customer at time t.

17. The system of claim 13, wherein profits from contacting all customers associated with the portfolio of monitored accounts is described by a formula, profit=Σₜ₌₁^{T}Σᵢ₌₁ⁿaᵢⱼₜpᵢⱼₜ.

18. The system of claim 17, wherein the risk-driven campaign optimization strategy is defined by an equation:
$${max}_{a} {\sum }_{i = 1}^{n} {a}_{it} ( {e}^{- {N}_{i τ}} {l}_{i} {r}_{i} ( 1 - {e}^{- {ϕ}_{i} ( t ) h ( ∇ {t}_{i}^{c} )} ) - {C}_{c} )$$
$$s . t . {\sum }_{i = 1}^{n} {a}_{i} < {N}_{c}$$
$${a}_{it} ∈ \{ 0 , 1 \} .$$

19. The system of claim 17, wherein the one or more communication channels comprise at least two communication channels and the risk-driven campaign optimization strategy is defined by an equation:
$${max}_{a} {\sum }_{j = 1}^{k} {\sum }_{i = 1}^{n} {a}_{ijt} ( {e}^{- ( {μ}_{j} {N}_{ijt} )} {l}_{i} {r}_{i} ( 1 - {e}^{- {B}_{j} {ϕ}_{i} ( t ) h ( ∇ {t}_{i}^{j} )} ) - {C}_{j} )$$
$$s . t . {\sum }_{i = 1}^{n} {a}_{ij} < {N}_{j} ∀ j$$
$${\sum }_{j = 1}^{k} {a}_{ij} = 1 ∀ i$$
$${a}_{ijt} ∈ \{ 0 , 1 \} .$$

20. The system of claim 13, wherein the risk-driven campaign optimization strategy comprises at least two sub-modules relating to single and multi-channel communications.

21. The system of claim 13, wherein one or more communication channels comprise one or more of telephone calls, e-mails, text messages, web-chats, and social media messages.

22. The system of claim 13, wherein the portfolio of monitored accounts comprise selectively one of more of the following: loans, insurance claims, pending bills/liabilities, and medical/health actions.

23. The system of claim 13, wherein the campaign optimization strategy is selectively one of the following: risk of delinquency reduction, cost optimization, and targeting.

24. The system of claim 13, wherein when generating the solution maximizing advantage to the campaign optimization problem the specialized computing device factors the one or more derived risk models regarding one or more monitored accounts of the portfolio of monitored accounts to determine whether to contact the customer and which communications channel of the one or more communications channels to utilize to contact the customer.
